(19) United States
(12) Patent Application Publication
(10) Pub. No.: US 2007/0081736 A1
(43) Pub. Date: Apr. 12, 2007

(54) Tracking of a subimage in a sequence of images

(75) Inventors: Christophe Kefeder, BARON-SUR-ODON (FR); Raymond-Henri Devinoy, Luc-Sur-Mer (FR)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/578,279

(22) PCT Filed: Oct. 27, 2004
(86) PCT No.: PCT/IB04/03615

§ 371 Date: May 5, 2006

(30) Foreign Application Priority Data
Nov. 5, 2003 (FR) 0350791

(51) Int. Cl. G06K 9/40; G06K 9/00

(52) U.S. Cl. 382/254; 382/103; 382/170

(57) ABSTRACT

The method provides the identification, in a succession of acquired images each formed from a matrix of pixels, of a following sub-image extracted from a following acquired image corresponding to a prior sub-image extracted from a prior acquired image. The method comprises the steps of: —calculating, for the prior sub-image, at least one distribution of a characteristic quantity of each pixel for blocks forming a predefined partitioning of the sub-image; —calculating the same distribution for at least two would-be sub-images of the second format extracted from the following acquired image; and—determining the corresponding following sub-image from among the would-be sub-images, as the sub-image where the or each calculated distribution has the highest correlation with the same calculated distribution for the prior sub-image.

### FIELD OF THE INVENTION

The present invention relates to a method of identification, in a succession of acquired images each formed from a matrix of pixels to a first format, of a following sub-image extracted from a following acquired image corresponding to a prior sub-image extracted from a prior acquired image, said sub-images being formed from a matrix of pixels to a second format smaller than the first format.

### BACKGROUND OF THE INVENTION

Many video sequence acquisition devices are equipped with image stabilization means enabling the recorded image not to be disturbed by unwanted and unintentional movements of the operator handling the camera.

In order to stabilize the image, some devices are provided with correction mechanisms acting directly on the optical elements of the camera. These devices are complex, bulky and not well suited to small items of equipment.

There are also known video signal processing methods making it possible, by analysis of successive images, to stabilize the images recorded.

Such methods provide for the camera to acquire digital images whose format is larger than the format of the images which are to be recorded, the latter then constituting sub-images of the main images acquired by the camera.

In order to stabilize the image, it is known how to determine, from a prior sub-image taken from a prior acquired image, the following sub-image corresponding to the prior sub-image in the following acquired image. From the knowledge of the prior and following sub-images, it is possible to determine any movement that took place between these two corresponding images and to correct such movement in order to eliminate the effect of the unintentional movements of the operator.

An image stabilization method is described in particular in the document EP-1.117.251. This method makes provision for dividing an acquired image into a set of blocks covering the image and for determining, for each block, a movement vector characterizing the movement of this block from one image to the following image. A movement histogram is created for all the blocks. After filtering, the results of the histogram are averaged and the movement vector is taken as being equal to the average of the filtered movement vectors of the various blocks.

This method consumes a large amount of calculation time and therefore power since it is necessary, for each block in question, to determine a corresponding block in the following image. In addition, no algorithm is supplied in order to identify the following block from a prior block.

It is an object of the invention to propose a method of identifying a following sub-image corresponding to a prior sub-image of a succession of acquired images able to be used in a method of determining the movement of an image which can itself be used in an image stabilization method, so that the image stabilization method requires only a small number of calculation operations and consumes little power.

### SUMMARY OF THE INVENTION

To this end, the object of the invention is an identification method comprising the steps consisting of:
calculating, for the prior sub-image, at least one distribution of a characteristic quantity of each pixel for blocks forming a predefined partitioning of the sub-image;
calculating, the same distribution for at least two would-be sub-images to the second format extracted from the following acquired image; and
determining the corresponding following sub-image from among the would-be sub-images, as the sub-image where the or each calculated distribution has the highest correlation with the same calculated distribution for the prior sub-image according to a predefined correlation law.

Calculating a distribution in order to determine the corresponding following sub-image is simple and inexpensive in calculation power and nevertheless makes it possible to determine the corresponding following sub-image with satisfactory precision.

According to particular embodiments, the method comprises one or more of the following characteristics:
it comprises the steps of:
calculating an extended distribution for an extended range of the following acquired image;
calculating the correlations between the calculated distribution for the prior sub-image and a corresponding portion of the extended distribution for several shifts of the prior sub-image with respect to the following acquired image; and
determining the corresponding following sub-image as the sub-image of the following acquired image corresponding to the shift of the prior sub-image with respect to the following acquired image for which the calculated correlation between the distributions is the highest;
the blocks forming a predefined partitioning of the sub-image for calculating at least one distribution are rows and/or columns of the sub-image;
said characteristic quantity of each pixel is a parameter chosen from the group consisting of luminance, blue chrominance, red chrominance, red component, green component and blue component; and
the correlation law is defined as the inverse of the Euclidean distance separating two distributions.

The invention also relates to a method of determining the movement, in a succession of acquired images each formed from a matrix of pixels to a first format, of a following sub-image extracted from a following acquired image with respect to a corresponding prior sub-image extracted from a prior acquired image, said sub-images being formed from a matrix of pixels to a second format smaller than the first format, the method comprising the steps consisting of:
identifying, in the following acquired image, the following sub-image corresponding to the prior sub-image by the use of a method as defined; and
calculating any movement between the prior and following sub-images from the position of the prior and following sub-images in the prior and following acquired images.

It also has as its object a method of stabilizing images in a succession of acquired images each formed from a matrix of pixels to a first format, comprising the steps consisting of:
determining any movement in the succession of acquired images of a following sub-image issuing from a following acquired image with respect to a corresponding prior sub-image issuing from a prior acquired image, by the use of a movement method as defined above;
correcting said determined movement in order to take account of the effect of an intentional movement and to eliminate the effect of an unintentional movement; and
adopting as the following image a sub-image of the following acquired image shifted from the prior sub-image by said corrected movement.

It also has as its object a computer program product for a data processing unit, comprising a set of instructions for executing the steps of the method as defined above, when said program is executed by a data processing unit.

Finally, the invention has as its object:
a device for identification, in a succession of acquired images each formed from a matrix of pixels to a first format, of a following sub-image extracted from a following acquired image corresponding to a prior sub-image extracted from a prior acquired image, said sub-images being formed from a matrix of pixels to a second format smaller than the first format, the device comprising:
means for calculating, for the prior sub-image, at least one distribution of a characteristic quantity of each pixel for blocks forming a predefined partitioning of the sub-image;
means for calculating the same distribution for at least two would-be sub-images to the second format extracted from the following acquired image; and
means for determining the corresponding following sub-image from among the would-be sub-images, as the sub-image where the or each calculated distribution has the highest correlation with the same distribution calculated for the prior sub-image according to a predefined correlation law;
a device for determining the movement, in a succession of acquired images each formed from a matrix of pixels to a first format, of a following sub-image extracted from a following acquired image with respect to a corresponding prior sub-image extracted from a prior acquired image, said sub-images being formed from a matrix of pixels to a second format smaller than the first format, the device comprising:
an identification device as above for identifying in the following acquired image the following sub-image corresponding to the prior sub-image; and
means for calculating the movement between the prior and following sub-images from the position of the prior and following sub-images in the prior and following acquired images;
a device for stabilizing images in a succession of acquired images each formed from a matrix of pixels to a first format, comprising:
a device for determining the movement as defined above for determining the movement in the succession of acquired images of a following sub-image issuing from a following acquired image with respect to a corresponding prior sub-image issuing from a prior acquired image;
means for correcting said determined movement for taking account of the effect of an intentional movement and eliminating the effect of an unintentional movement; and
means for adopting, as the following sub-image, a sub-image of the following acquired image shifted from the prior sub-image by said corrected movement.

### BRIEF DESCRIPTION OF THE DRAWINGS

The invention will be further described with reference to examples of embodiments shown in the drawings to which, however, the invention is not restricted.

FIG. 1 is a schematic view of video compression equipment using an image stabilization device according to the invention;

FIG. 2 is a flow chart explaining the image stabilization method according to the invention;

FIG. 3 is a schematic view of a prior image illustrating the calculation of the horizontal and vertical histograms used in the method according to the invention;

FIG. 4 is a schematic view of the following image of the image of FIG. 3 illustrating the calculation of the horizontal and vertical histograms used in the method according to the invention;

FIG. 5 is a curve illustrating the method of correlating the histograms obtained during the implementation of the method according to the invention;

FIG. 6 is a curve illustrating the determination of the movement vector by implementation of the method according to the invention; and

FIG. 7 is a schematic view of a portable image recording and display device.

### DESCRIPTION OF PREFERRED EMBODIMENTS

The image stabilization method according to the invention is particularly adapted to be used in portable equipment for acquiring video sequences, such as a mobile telephone equipped with an integral camera and means of transmitting the acquired video sequence after the latter has been compressed.

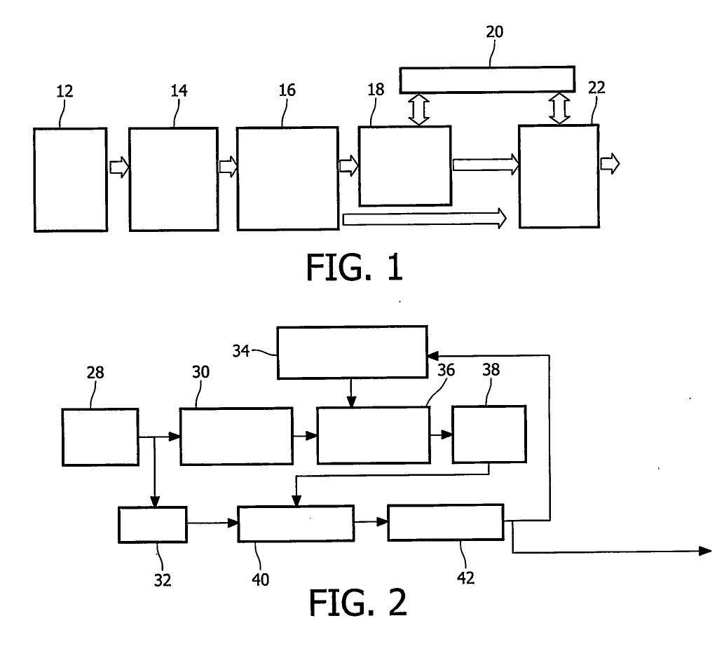

FIG. 1 depicts schematically the structure of video compression equipment used in a portable telephone, this equipment comprising an image stabilization stage according to the invention.

The processing chain of the video compression equipment comprises digital image acquisition means 12 consisting for example of the lens of a camera associated with a matrix of sensors. The digital image acquired is formed from a matrix of pixels. Each pixel constitutes an image element characterized by various variables such as luminance, blue chrominance, red chrominance, red component, green component or blue component.

The acquired images have a first format. They are for example 700×500 pixels.

The images which are to be encoded and compressed by the equipment have a second format smaller than the format of the acquired images. The images to be encoded therefore consist of sub-images issuing from the acquired images. The second format is for example 640×480 pixels.

The acquired images of 700×•pixels supplied by the acquisition means 12 are processed by image stabilization means 14 according to the invention. These means will be described in detail later in the description. The images obtained at the output of the stabilization means are stabilized sub-images to the second format of 640×480 pixels.

As is known per se, the succession of sub-images thus obtained is then compressed in the mobile telephone, before being transmitted.

To this end, the sub-images are broken down by means 16 of breaking down into macroblocks of 8×8 pixels. These macroblocks are each sent to means 18 of estimating a movement vector of the macroblock with respect to its position in the previous sub-image. To this end, the compression equipment comprises means 20 of storing the previous sub-images. It also comprises means 22 of coding the differences between each macroblock to be coded and its antecedent in the previous sub-image.

These means 22 receive as an input the movement vector of each macroblock produced by the estimation means 18, the corresponding macroblock issuing from the decomposition means 16 and the prior macroblock of the previous sub-image stored in the storage means 20.

The information for each macroblock consisting of the movement vector and the coded differences are transmitted by the telephone to a receiver, where the information is decoded and the image sequence is reconstituted.

FIG. 2 depicts a simplified flow diagram of the algorithm used for the image stabilization means 14 according to the invention.

Advantageously, the image stabilization means 14 are produced in the form of an adapted hard-wired electronic circuit, such as an ASIC.

In a variant, the various stabilization steps are performed by a processor such as a DSP using an adapted program.

According to the method according to the invention, the acquired images are processed successively as they are acquired. Thus a sub-image corresponding to a prior sub-image is determined for each new acquired image.

The steps of the method illustrated in FIG. 2 are therefore implemented for each new acquired image.

It is thus assumed that the acquired prior image denoted Aₜ is known as well as the stabilized prior sub-image denoted SAₜ extracted from the prior acquired image Aₜ.

When the method is implemented, the following image denoted Aₜ₊₁ is acquired at step 28.

The image stabilization means first of all provide, at step 30, a calculation of a vertical and horizontal histogram of a characteristic quantity of the pixels of the following image Aₜ₊₁ issuing from the image acquisition means 12.

The characteristic quantity considered in the histograms for each pixel is for example the luminance of each pixel, or the blue chrominance, the red chrominance, the red component, the green component or the blue component of each pixel.

The histogram is established for predefined blocks of the following acquired image Aₜ₊₁. This acquired image has, as indicated previously, a format of 700×•pixels.

More rigorously, a distribution of a characteristic quantity of each pixel for all the blocks defined is established. Although the histogram is the graphical representation of this distribution, the term histogram will be used in the remainder of the description to designate this distribution, this term being more normally used in the art in question.

For example, the horizontal histogram denoted Hₜ₊₁^{h} is composed of sums denoted H₁ of the characteristic quantities of each pixel, for each of the lines l of the image Aₜ₊₁. In other words, each point of the histogram is defined for a line 1 by the following formula:

$${H}_{1} = {\sum }_{i = 1}^{NCI} {q}_{i}$$

where:

h₁ is the sum of the characteristic quantities of the pixels of line l; 1 is the number of line l; here l∈[1; 500];

qᵢ is the characteristic quantity of the pixel i in line l, and NCI is the number of columns in the image; here NCI=700.

Likewise, a vertical histogram denoted Hₜ₊₁^{v} is established for the image Aₜ₊₁. Each point H_{c} of the histogram corresponding to a column c is defined by:

$${H}_{c} = {\sum }_{j = 1}^{NLI} {q}_{j}$$

where:

H_{c} is the sum of the characteristic quantities of the pixels in column c;

c is the number of column c; here c∈[1; 700];

qⱼ is the characteristic quantity of the pixel j of column c, and

NLI is the number of lines in the image.

These histograms Hₜ₊₁^{h} and Hₜ₊₁^{v} are calculated for the entire extent of the images collected.

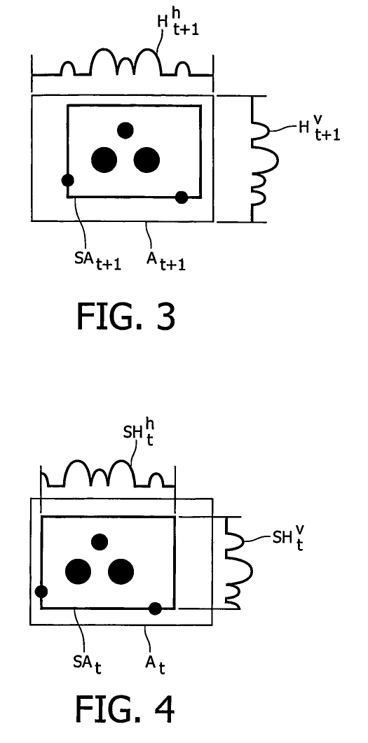

An example of such histograms is depicted in FIG. 3, where the characteristic quantity of each pixel is the light intensity of the pixel.

The image acquired to the format of 700×500 pixels is temporarily stored in a video memory of the FIFO (first in first out) type at step 32.

The histograms of the previous extracted sub-image SAₜ of the sequence of the images which is to be stabilized are stored so as to be used subsequently at step 34.

The horizontal SHₜ^{h} and vertical SHₜ^{v} histograms of the sub-image stored in the means 32 are obtained by extracting some of the larger histograms of the acquired images calculated by the means 30, as will be disclosed later in the description. It is therefore a case in fact of sub-histograms whose extent is limited to the sub-image SAₜ of the second format, as disclosed in FIG. 4.

At step 36, a calculation of the distances between the histograms Hₜ₊₁^{h} and Hₜ₊₁^{v} and the histograms SHₜ^{h} and SHₜ^{v} of the following acquired image Aₜ₊₁ and of the prior sub-image SAₜ is made. To do this, the horizontal histogram and the vertical histogram of the acquired image and the vertical and horizontal histograms of the prior extracted sub-image are used.

A similar processing is carried out for the horizontal and vertical histograms. Only the processing carried out on the horizontal histograms is described in detail below.

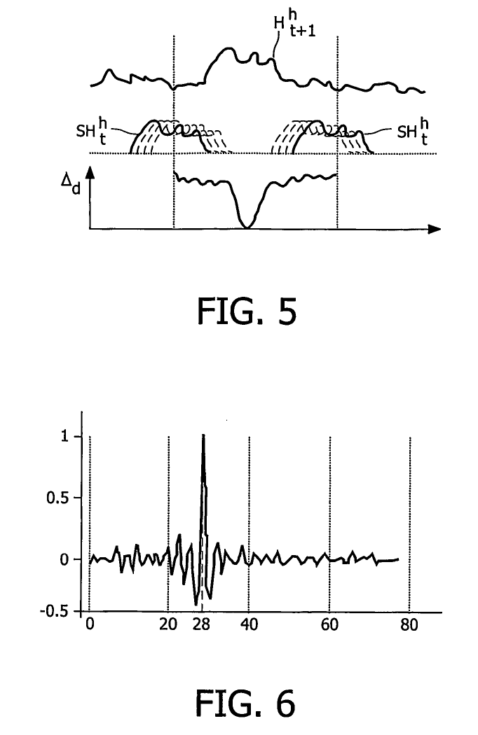

A set of distances between the horizontal histogram SHₜ^{h} of the prior sub-image SAₜ and the horizontal histogram Hₜ₊₁^{h} of the following acquired image Aₜ₊₁^{h} is calculated. These distances are calculated for would-be images extracted from the following acquired image Aₜ₊₁ whose format is that of a sub-image, namely 640×480 points. The various would-be sub-images considered are offset from each other by one pixel over the entire extent of the prior acquired image, so that sixty successive would-be images are considered, as illustrated in FIG. 5, between the would-be sub-image and the prior acquired image Aₜ.

Each distance denoted D_{d} for an offset of d pixels is defined by the difference between the sums of the characteristic quantities of the pixels of each block, here each column, over the extent of the histogram, namely by the formula:

$${D}_{d} = {\sum }_{i = 1}^{NCSI} \vert {y}_{i + d}^{I} - {y}_{i}^{SI} \vert .$$

where

NCSI is the number of columns in the would-be sub-image; here NCSI=640;

Y_{i+d}^{I} is the quantity of the histogram corresponding to the column i+d for the following image Aₜ₊₁;

yᵢ^{SI} is the quantity of the histogram corresponding to the column i for the would-be sub-image.

The offset between the preceding sub-image SAₜ and the corresponding following sub-image SAₜ₊₁ is determined, at step 38, from the results of the calculation of the distances. To this end, among the calculated distances the offset m corresponding to the smallest distance D_{d} is adopted.

The smallest distance is preferably determined from the curve formed by the distances D_{d} considering the point on this curve for which the second derivative is the greatest. A curve representing the second derivative of the function D_{d} is illustrated in FIG. 6. In this example, the offset is equal to 28 pixels.

The offset m thus determined makes it possible to determine, in the following acquired image Aₜ₊₁, the sub-image corresponding best to the prior sub-image SAₜ and in particular to determine the horizontal offset between these two images.

Steps 36 and 38 are implemented also for a vertical offset, considering the vertical histograms.

The offset thus determined between the corresponding sub-images SAₜ and SAₜ₊₁ is then corrected at step 40. This offset is corrected so as not to take account of any unintentional vibrations. A correction algorithm of this type is known per se and will not be described in detail.

The corrected following sub-image SAₜ₊₁ is then extracted from the following image stored at step 42 from the corrected offset established at step 40. This following corresponding sub-image is then sent to the breakdown module 16.

It will be understood that, with such a stabilization means, the calculations necessary for determining the offset between the two successive corresponding images is relatively small, which makes it possible for these calculations to be carried out with limited resources, in particular limited power consumption.

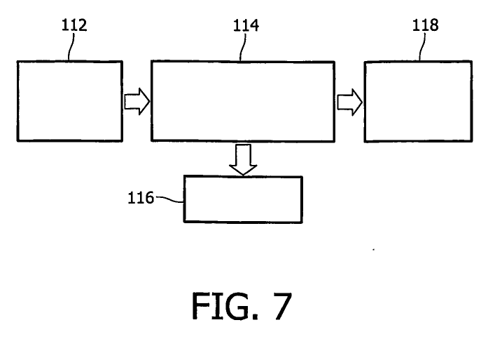

FIG. 7 depicts another device implementing an image stabilizer by histogram according to the invention. This device is a camcorder comprising a set of sensors 112 allowing the acquisition of an image, an image stabilization module 114 as described above making it possible to produce stabilized sub-images as an output. These sub-images are sent to recording means 116 and, simultaneously, to a display screen such as a liquid crystal screen 118 enabling the operator to display the sequence of recorded images.

1. A method of identification, in a succession of acquired images each formed from a matrix of pixels to a first format, of a following sub-image (SAₜ₊₁) extracted from a following acquired image corresponding to a prior sub-image extracted from a prior acquired image said sub-images being formed from a matrix of pixels to a second format smaller than the first format, the method comprising the steps consisting of:
calculating, for the prior sub-image at least one distribution of a characteristic quantity of each pixel for blocks forming a predefined partitioning of the sub-image;
calculating the same distribution for at least two would-be sub-images of the second format extracted from the following acquired image and
determining the corresponding following sub-image from among the would-be sub-images, as the sub-image where the or each calculated distribution has the highest correlation with the same calculated distribution for the prior sub-image according to a predefined correlation law.

2. A method as claimed in claim 1, characterized in that it comprises the steps of:
calculating an extended distribution for an extended range of the following acquired image
calculating the correlations between the calculated distribution for the prior sub-image and a corresponding portion of the extended distribution for several shifts of the prior sub-image with respect to the following acquired image and
determining the corresponding following sub-image as the sub-image of the following acquired image corresponding to the shift of the prior sub-image with respect to the following acquired image for which the calculated correlation between the distributions is the highest.

3. A method as claimed in claim 1, characterized in that the blocks forming a predefined partitioning of the sub-image for calculating at least one distribution are lines and/or columns of the sub-image.

4. A method as claimed in claim 1, characterized in that said characteristic quantity of each pixel is a parameter chosen from the group consisting of luminance, blue chrominance, red chrominance, red component, green component and blue component.

5. A method as claimed in claim 1, characterized in that the correlation law is defined as the inverse of the Euclidean distance separating two distributions.

6. A method of determining the movement, in a succession of acquired images each formed from a matrix of pixels to a first format, of a following sub-image extracted from a following acquired image with respect to a corresponding prior sub-image extracted from a prior acquired image said sub-images being formed from a matrix of pixels to a second format smaller than the first format, the method comprising the steps consisting of:
identifying, in the following acquired image the following sub-image corresponding to the prior sub-image by the use of a method as claimed in claim 1; and
calculating any movement between the prior and following sub-images from the position of the prior and following sub-images in the prior and following acquired images.

7. A method of stabilizing images in a succession of acquired images each formed from a matrix of pixels to a first format, comprising the steps consisting of:
determining any movement in the succession of acquired images of a following sub-image issuing from a following acquired image with respect to a corresponding prior sub-image issuing from a prior acquired image by the use of a movement method as claimed in claim 6;
correcting said determined movement in order to take account of the effect of an intentional movement and to eliminate the effect of an unintentional movement; and
adopting as the following image a sub-image of the following acquired image shifted from the prior sub-image by said corrected movement.

8. A computer program product for a data processing unit, comprising a set of instructions for executing steps of the method as claimed in claim 1, when said program is executed by a data processing unit.

9. A device for identification, in a succession of acquired images each formed from a matrix of pixels to a first format, of a following sub-image (SAₜ₊₁) extracted from a following acquired image corresponding to a prior sub-image extracted from a prior acquired image said sub-images being formed from a matrix of pixels to a second format smaller than the first format, the device comprising:
means for calculating, for the prior sub-image at least one distribution of a characteristic quantity of each pixel for blocks forming a predefined partitioning of the sub-image;
means for calculating the same distribution for at least two would-be sub-images to the second format extracted from the following acquired image and
means for determining the corresponding following sub-image from among the would-be sub-images, as the sub-image where the or each calculated distribution has the highest correlation with the same distribution calculated for the prior sub-image according to a predefined correlation law.

10. A device for determining the movement, in a succession of acquired images each formed from a matrix of pixels to a first format, of a following sub-image extracted from a following acquired image with respect to a corresponding prior sub-image extracted from a prior acquired image said sub-images being formed from a matrix of pixels to a second format smaller than the first format, the device comprising:
an identification device as claimed in claim 9 for identifying in the following acquired image the following sub-image corresponding to the prior sub-image and
means for calculating the movement between the prior and following sub-images from the position of the prior and following sub-images in the prior and following acquired images.

11. A device for stabilizing images in a succession of acquired images each formed from a matrix of pixels to a first format, comprising:
a device for determining the movement as claimed in claim 10 for determining the movement in the succession of acquired images of a following sub-image issuing from a following acquired image with respect to a corresponding prior sub-image issuing from a prior acquired image
means for correcting said determined movement for taking account of the effect of an intentional movement and eliminating the effect of an unintentional movement; and
means for adopting, as the following sub-image a sub-image of the following acquired image shifted from the prior sub-image by said corrected movement.
